(19) United States
(12) Patent Application Publication
(10) Pub. No.: US 2003/0200248 A1
(43) Pub. Date: Oct. 23, 2003

(54) Methods and apparatus for design of processes and monitoring performance of those processes

(75) Inventors: Daniel B. Dombrosky, Apex, NC (US); James R. Goff, Raleigh, NC (US)

Correspondence Address: PRIEST & GOLDSTEIN PLLC, 5015 SOUTHPARK DRIVE, SUITE 230, DURHAM, NC, 27713-7736, US

(73) Assignee: GE Mortgage Holdings, LLC, Raleigh, NC (US)

(21) Appl. No.: 09/683,370

(22) Filed: Dec. 19, 2001

(51) Int. Cl. G06F 9/00

(52) U.S. Cl. 709/100

(57) ABSTRACT

A system for creation and storage of process descriptions and collection and retrieval of evaluation information is described. The system comprises a process description library for storing a plurality of process descriptions in electronically retrievable format, an evaluation information database for storing a plurality of evaluation information documents stored in electronically retrievable format and a process description manager operative to create the process descriptions. The process description manager is operative to include in one or more of the process descriptions one or more links to evaluation information documents, each link causing retrieval of an associated evaluation information document upon activation of the link. The process description manager is operative to store each process description in the process description library upon creation of the process description.

CROSS REFERENCE TO RELATED APPLICATIONS

The present application is related to U.S. application Ser. No. 09/563,517, filed May 3, 2000, entitled Methods and Apparatus for Providing a Quality Control Management System, and to U.S. application Ser. No. 09/564,012, filed May 3, 2000, entitled Methods and Apparatus for Providing a Quality Control Management System, both of which are incorporated by reference herein in their entirety.

### BACKGROUND OF INVENTION

The present invention relates generally to improved techniques for designing processes and monitoring performance of the processes. More particularly, the invention relates to electronically accessible mechanisms for preparing descriptions of processes, associating each process step making up an overall process with tools needed to perform that process step, receiving data relating to performance of process steps and retrieving the data relating to performance of the process and process steps.

Conducting a business, manufacturing goods, providing services to customers and the like all include the performance of numerous processes. Most, if not all, of these processes can be described in terms of individual process steps. For example, a simple process of making and distributing 100 copies of a presentation may involve the process steps of printing a single copy of the presentation, preparing a list of recipients of the copies, preparing instructions for copying of the presentation, to a copy shop, handing the presentation and the instructions to copy shop personnel, returning to the copy shop, receiving the copies of the presentation from copy shop personnel, counting the copies, examining one or more copies for correctness and distributing the copies to persons on the list.

In undertaking an enterprise, for example operating a business, it is important to collect and monitor data indicating how well the various processes carried on in order to conduct the enterprise are performed. In monitoring a complex enterprise, large amounts of data may be collected, and it is important to assemble this data in ways which allow evaluation of the performance of a process being monitored and to provide easy ways for someone reviewing the performance of a particular process to retrieve data, or evaluation information, indicating how well the process is being performed and giving insight into desired aspects of the performance of the process.

How well a process is performed depends in large part on how well the individual process steps are performed. In order to monitor how well a process is performed, it is useful to collect and analyze information not only about the satisfactory or unsatisfactory performance of the process as a whole, but also about how well each one of a number of selected process steps is performed. This information may include whether or not the process step was performed correctly, whether or not the process step was performed on schedule, whether or not excessive resources were devoted to performing the process step, or any other information deemed useful for evaluating performance of the process step.

A particularly useful source of information is the customer for whom the process step is being performed. Typically, the customer will not be motivated to say that the process step has been performed correctly or on time if in fact it has not. However, the customer is not typically directly involved in monitoring performance of the process step or in developing strategies to improve performance. The customer may ultimately benefit if performance improves, but this benefit is uncertain and the benefit to the customer from improved service is not as great as is the benefit to the provider from improving the service it provides. If the customer is dissatisfied with how a process step is performed by a particular provider, he or she can remedy the situation by changing providers. Therefore, the customer is typically not strongly motivated to counsel a service provider on specific areas in which performance fell short. The furnishing of such information can be regarded as a favor from the customer to the provider. In order to motivate the customer to provide performance information, it is beneficial to make the provision of such information as convenient for the customer as possible.

It is also useful to make the retrieval and analysis of information relating to a process step as convenient as possible for the person evaluating performance of a process involving that process step. Often, managers evaluating performance of a process find it too cumbersome to review evaluation information relating to each process step making up a process. This is particularly true if a single upper level process involves the performance of numerous process steps, some of which in turn involve the performance of lower level processes A manager may focus on an overall upper level process rather than individual process steps making up the process, and evaluation information relating to one or more individual process steps may escape notice, even if improving the performance of these process steps would significantly improve performance of the overall process. In order to motivate a manager to examine information useful for evaluating the performance of process steps which make up a process, it is beneficial to make the information as easy to retrieve as possible.

### SUMMARY OF INVENTION

To this end, a method according to an aspect of the present invention of and evaluating information relating to the quality of performance of a process comprises the steps of examining the process to identify the different process steps required by the process. The method also comprises collecting evaluation information related to one or more process steps and of the overall process and of processing the evaluation information to form a collection of evaluation information documents, each evaluation information document including evaluation information relating to quality of performance of one or more process steps or of the overall process, and storing the evaluation information documents in electronically retrievable format. The method further comprises creating a description of each process step, organizing the process step descriptions into a process description comprising a sequence of process step descriptions, adding links to appropriate evaluation information documents within the process description, each link retrieving an evaluation information document associated with the link upon activation of the link, and storing the process description in electronically retrievable format.

A system for creation and storage of process descriptions and collection and retrieval of evaluation information according to a further aspect of the invention comprises a process description library for storing a plurality of process descriptions in electronically retrievable format, an evaluation information database for storing a plurality of evaluation information documents stored in electronically retrievable format and a process description manager operative to create the process descriptions, the process description manager being operative to include in one or more of the process descriptions one or more links to evaluation information documents, each link causing retrieval of an associated evaluation information document upon activation of the link, the process description manager being operative to store each process description in the process description library upon creation of the process description.

A more complete understanding of the invention, as well as further features and advantages of the invention, will be apparent from the following Detailed Description and from the claims which follow below.

### BRIEF DESCRIPTION OF DRAWINGS

FIG. 1 illustrates a system for creating, storing and retrieving process descriptions and collecting, storing and retrieving evaluation information according to an aspect of the present invention;

FIGS. 2A and 2B illustrate a hypertext page displaying a process description for a core process according to an aspect of the present invention;

FIG. 3 illustrates a hypertext page displaying evaluation information retrieved by following a link contained in the hypertext page of FIGS. 2A and 2B;

FIGS. 4A and 4B illustrate a hypertext page displaying an intermediate level process description for an intermediate level process according to an aspect of the present invention;

FIG. 5 illustrates a hypertext page displaying resources available for carrying out a process described in the intermediate level process description of FIGS. 4A and 4B, reached by following a link contained in the intermediate level process description;

FIG. 6 illustrates evaluation information retrieved by following a link contained in the hypertext page of FIGS. 4A and 4B;

FIG. 7 illustrates a hypertext page displaying a process description for a lower level process, reached by following a link embedded in a process step description in the intermediate level process description illustrated in FIGS. 4A and 4B;

FIG. 8 illustrates a method of creating process descriptions and collecting and storing evaluation information according to an aspect of the present invention;

FIG. 9 illustrates a method of performing a process according to an aspect of the present invention; and

FIG. 10 illustrates a method of retrieving evaluation information linked to elements of a process description according to an aspect of the present invention.

### DETAILED DESCRIPTION

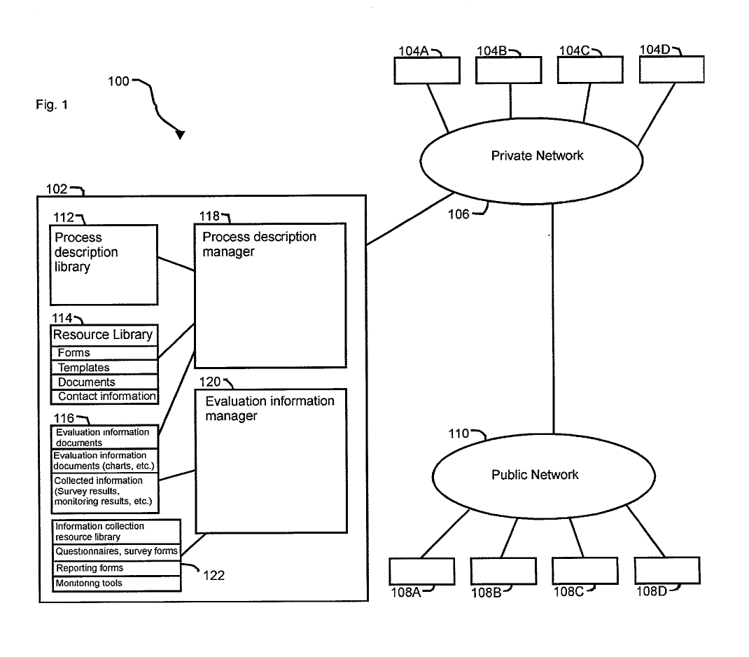

FIG. 1 illustrates a system 100 according to an aspect of the present invention, suitable for use in managing the creation of process descriptions and the collection and review of data describing how well the processes are performed. The system 100 includes a central server 102 connected to a plurality of user computers 104A-104D by a private network 106. The private network 106 may suitably be a corporate intranet. The central server 102 may also communicate with a plurality of customer computers 108A-108D. Communication between the central server 102 and the customer computers 108A-108D may suitably be accomplished through a connection between the network 106 and a publicly accessible network 110, such as the Internet. Transmissions between the public network 110 and the private network 106 are preferably controlled in order to maintain security of information on the server 102 and the user computers 104A-104D. It will be recognized, however, that the server 102 and the user computers 104A-104D may be connected to the public network 110, provided that proper security measures are taken to prevent compromise of proprietary information or other breaches of security.

The server 102 hosts a process description library 12 containing a set of process descriptions. Each process description is preferably an electronically retrievable document, for example a hypertext page or linked set of hypertext pages. Each process description provides instructions and shows process flow for accomplishing a category of process, for example creating a new product, marketing a product, negotiation and execution of a contract or other categories of processes which may be undertaken. A process description preferably does not describe a specific process, such as negotiation of a particular contract, but instead describes the process category with sufficient generality that it can be applied to a wide variety of processes in the category. Each process description may suitably allow for accommodation to different conditions and event flows so that it can be applied to variations of a process. For example, a description of contract negotiation may have a decision point at which the dollar value of the contract is examined and a higher level of approval is sought if the contract is over a specified dollar value, but is not sought if the contract is under that value.

Each process description comprises a plurality of process step descriptions. Each process step description describes an action or set of actions to be taken to accomplish a particular step of the process, and may also refer or link to lower level processes which need to be accomplished in order to perform a step of a higher level process.

For example, a higher level process of business development may include steps of marketing, negotiation and financing. A step of a higher level process, that is, a higher level process step, may comprise a lower level process which itself comprises a sequence of lower level process steps. Such a higher level process step description may therefore include a link to a lower level process description, used to implement the higher level process step.

In order to facilitate the inclusion of lower level processes as steps of higher level processes, process descriptions may be organized in a hierarchy and categorized as higher level or lower level and facilities may be provided to browse through a collection of process descriptions of a particular level, as an aid to selecting lower level process descriptions which may be useful for inclusion as steps of a higher level process. For example, a process may be characterized as a core process central to the operation of the business. An example of a core process might be business development. Another process, for example sales, might be characterized as an intermediate level process performed to accomplish an aspect of the core process of business development. Still another process, for example the preparation of a sales presentation, might be characterized as a lower level process performed to accomplish an aspect of the sales process. Processes may be divided into as many hierarchical levels as desired, and a user preparing a process description for a higher level process may suitably include a lower level process as a process step of a higher level process. A hypertext link may be used as the process step description in the higher level process description, in order to allow linking to and retrieval of the lower level process.

In order to allow easy incorporation or linking of a lower level process into a higher level process description, the process library 112 preferably includes all process descriptions in use along with various indexing methods to allow retrieval of useful process descriptions. For example, process descriptions may be indexed by category, by hierarchy, or by a combination of category and hierarchy. Thus, a user building a process description for a core process may display all intermediate level processes in a particular category which are one level down from the core process level, in order to select one or more intermediate level processes for use as a step of the core process.

The server 102 also hosts a resource library 114, including resources and descriptions of and pointers to resources useful for performing various process steps. Resources may include, for example, forms or templates, documents or contact information for personnel or departments who can assist in carrying out a process step. A user creating a process description may include links to desired resources in the process description. The links may appear in or near a process step which requires the resources or which would benefit from the resources. For example, preparation of a standardized contract may require a contract form, and a link to a suitable form from the library may be included as the description of the process step of preparation of the form. To take another example, a process of preparing a presentation may include a step of preparing illustrative artwork, overheads or the like from a rough draft. A hypertext link may appear near the description of this step in a process description in order to allow retrieval of contact information for appropriate personnel in the art department.

The server also hosts an evaluation information database 116, including a plurality of evaluation information documents, each of which includes evaluation information relating to a particular process or process step, constructed to provide relevant information to a user. The evaluation information documents may suitably be charts, graphs, lists of statistical information or any other form of information deemed useful to evaluating performance of a process or process step. Each evaluation information document is preferably stored in electronically retrievable format, such as a hypertext page. The evaluation information database 11 6 may also be used to store collected evaluation information, for example reports, responses to surveys, automatic monitoring results and the like, which can be used in constructing evaluation information documents.

The server 102 also hosts a process description manager 118, preferably implemented as executable software, for building process and process step descriptions and storing them in the process description library 112. The process description manager 118 also manages retrieval and review of the process and process step descriptions. The server 102 also hosts an evaluation information manager 120 for use in collecting and storing evaluation information, assembling collected information into a usable format, for example a chart or set of charts and for managing retrieval and review of the evaluation information. The evaluation information manager is preferably implemented as executable software. The process description manager 118 and evaluation information manager 120 are preferably accessible to the user computers 104A-104D. In addition, the evaluation information manager 120 is preferably accessible to the customer computers 108A-108D, although suitable security precautions are preferably implemented before access is provided to the customer computers 108A-108D.

The server 102 also hosts an information collection resource library 122, in which various information collection resources, for example questionnaires, survey forms, reporting forms, automatic monitoring tools and other resources used to collect evaluation information are stored. The questionnaires and other resources may be retrieved from the library 122 as needed for use with the evaluation information manager 120. The evaluation information manager 120 may be used to collect evaluation information independently of any particular process description or process step description. Evaluation information may be collected in any number of ways, for example by taking periodic surveys, by requiring reports when processes are performed, by providing ways for customers to enter information about their satisfaction and about details, such as timeliness and correctness, or by automatically collecting information relating to various aspects of performance, for example the time a customer must spend waiting on hold before speaking to a representative. Once the evaluation information has been collected, it may be analyzed and processed. For example, statistical information can be extracted or evaluation information documents, such as charts or lists, may be prepared. Once the evaluation information has been processed, the evaluation information, as well as any evaluation information documents or other information produced by processing the evaluation information, may be stored in the database 108.

In addition to collecting and storing evaluation information independently of a particular process, it is also possible for a user preparing a process description to add facilities for collecting information relating to the process description and for processing and storing the information. Related evaluation information documents are preferably linked, and each document is preferably assigned a level indicating its position in a hierarchy of evaluation information documents. The levels assigned to evaluation information documents may suitably correspond to equivalent levels assigned to process description documents. Linking of evaluation information documents allows simultaneous retrieval of related documents. For example, a set of charts related to a particular process may be linked together, so that when one chart is retrieved an index to the other charts is displayed. A parent chart related to a level process may also have a number of associated child charts, each related to a lower level process, with the parent and the child charts being linked so that retrieval of the parent provides easy access to the children.

The evaluation information manager 118 allows navigation through evaluation information and selection of desired information for review according to any of a number of criteria. For example, evaluation information may relate to higher or lower level processes and may be central or peripheral to the functioning of an enterprise. Evaluation information may also be indexed by category, for example sales, contract preparation or the like. A user may freely review evaluation information either to evaluate how well various business processes are being performed, or alternatively to select evaluation information to be associated with a process description or process step description.

When a process description is to be designed, a user, for example user A employing computer 104A, analyzes the process and prepares a process description using the process description manager software 118. The process description may be designed by a single user or in a collaborative effort by multiple users employing one or more of the computers 104A-104D either simultaneously or at separate times. The process description preferably includes a general description of the process, with a sequence of process steps required to perform the process. The process description may suitably be a hypertext document and may suitably be in the form of a flowchart. One or more higher level process step descriptions may invoke a lower level process made up of a sequence of lower level process steps. Such a higher level process step description may be implemented as a hypertext link, so that activating the link retrieves a lower level process description for the lower level process from the library 105. To this end, the process description manager 118 includes facilities for retrieving process descriptions from the process description library 112 and incorporating the descriptions, or links to the descriptions, into any new process description being developed. The process description manager 118 also allows a user to place links to stored resources into a process description, so as to allow easy retrieval of resources or resource information from the resource library 114. For example, a process step description may be implemented as a hypertext link such that activating the link displays a list of available resources. Alternatively, such a link may be placed near the process step description.

The user also employs the evaluation information manager 114 to search the evaluation information database for evaluation information relevant to and affected by the process. The user places links to selected evaluation information as appropriate throughout the process description. If desired, a user may invoke the evaluation information manager 120 while developing a process description, in order to designate evaluation information to be collected in connection with the process description which is being developed and to process and format the evaluation information in order to provide links between the process description and the evaluation information.

Once the process description has been prepared, it is assigned an appropriate category and hierarchical level and stored in the process description library 112, and is accessible to any authorized user who wishes to retrieve it. When a process is to be performed, a user invokes the process description manager 118 and retrieves the desired process description from the process description library 112. The retrieved process description is used to provide guidance in performing the process.

In some cases, it is desired to collect evaluation information by supplying a questionnaire to a customer. A questionnaire may suitably be supplied to the customer by allowing the customer to access the evaluation information manager 120 in order to retrieve an appropriate questionnaire from the library 122 and to complete and submit the questionnaire. Once the questionnaire is received, the evaluation information is extracted and appropriately stored in the database 108.

If a user wishes to know how well a process is being performed, he or she can simply use the process description manager 118 to retrieve the appropriate process description from the process description library 112. As noted above, a process description preferably contains appropriately placed links for retrieving evaluation information. The user can simply examine the process description and activate desired links in order to retrieve evaluation information relating to the performance of a desired process step. Activating a link will invoke the evaluation information manager 120 and cause it to retrieve the correct document from the evaluation information database 116. Once the document has been retrieved, the user will be able to activate links within the document or use facilities provided by the evaluation information manager 120 to retrieve related information.

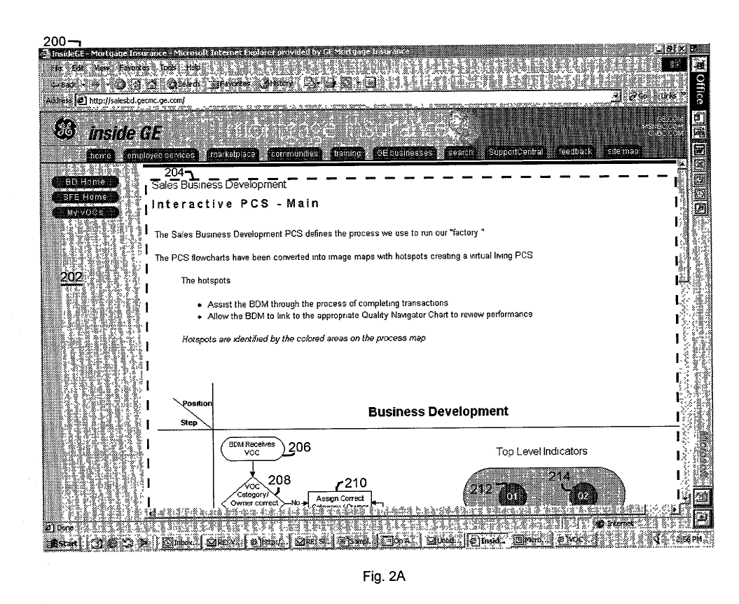

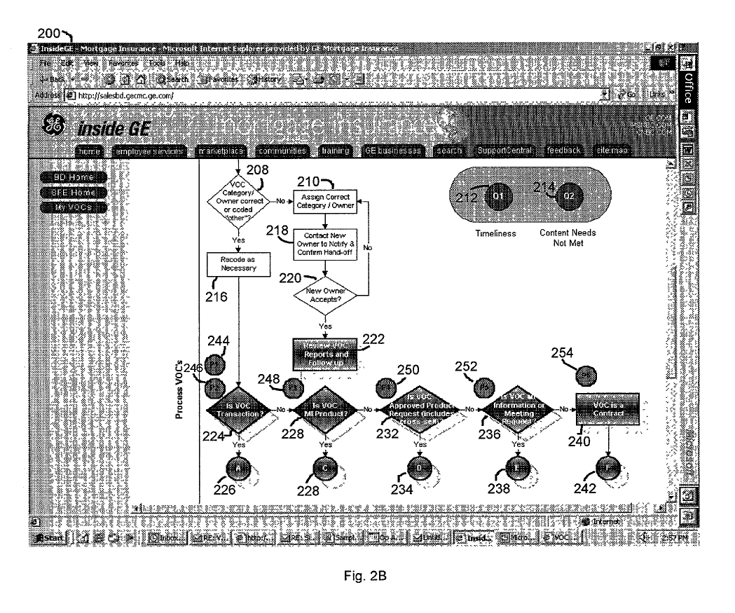

FIG. 2A illustrates a hypertext browser window 400 displaying a hypertext page 202 containing a process description 204 according an aspect of the present invention. The process description illustrates process steps to be performed in order to accomplish a business development process, and is an upper level process. The process description 204 is in the form of a flowchart showing a sequence of process steps such as the steps and decisions 206-210 to be performed in order to accomplish the process, as well as links 212 and 214 which allow easy access to evaluation information. The links 212 and 214 are more clearly illustrated in FIG. 2B and will be discussed in further detail below.

FIG. 2B illustrates additional content of the hypertext page 202, showing the process steps and flow which are not visible in FIG. 2A. The page 202 includes the links 212 and 214. The links 212 and 214 are links to evaluation information, which provides information about how well the described process is being performed. The links 212 and 214 are top level indicators and are labeled Q1 and Q2, respectively, in order to indicate that they link to information relating to overall outcome of a core process. The link 212 retrieves information related to timeliness of performance, and the link 214 retrieves information relating to correctness of performance. Specifically, the link 214 retrieves information indicating whether or not performance of the process delivers the correct content.

The core process description 204 includes core process step descriptions 206-210, as well as core process step descriptions and decision points 216-242. The core process step descriptions and decision points 222-242 are implemented as hypertext links and allow retrieval of additional information, such as resources to be used in performing the core process or lower level process descriptions describing lower level processes to be performed to accomplish a particular core process step. The process description 504 also includes hypertext links 544-554, for use in retrieving evaluation information related to performance of the core process steps associated with the links 544-546. For example, the links 544 and 546 are used to retrieve evaluation information associated with the core process steps 524 and 526 and the link 550 is used to retrieve evaluation information associated with the core process steps 532 and 534.

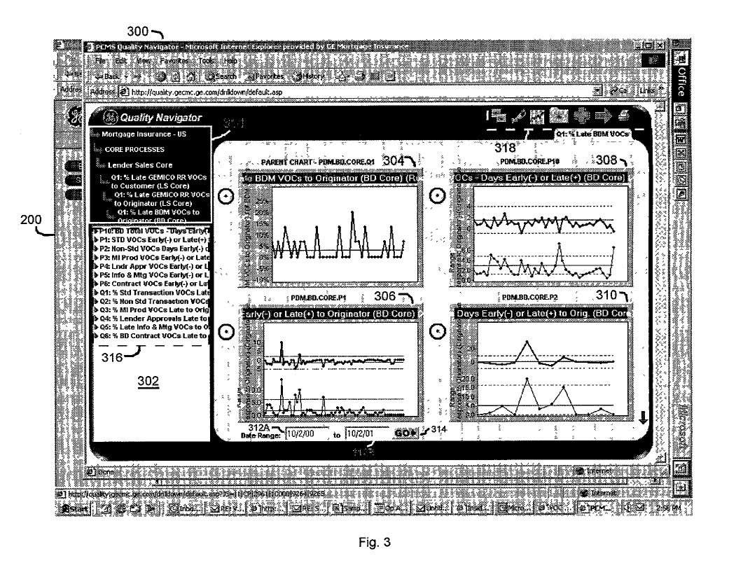

FIG. 3 illustrates a browser window 300, displaying a hypertext page 302 retrieved by activating the hypertext link 212 of FIGS. 2A and 2B. The browser window 200 can also be seen, but is obscured by the window 300. The page 302 displays charts 304-310, which are evaluation information documents, each illustrating timeliness of various aspects of the performance of the core process. The chart 304 illustrates the percentage of transaction reports relating to standard transactions which were submitted late to an originator, the chart 306 illustrates how many days early or late, on average, a report relating to a standard transaction was submitted to an originator, the chart 308 illustrates how many days early or late, on average, a report was submitted to a customer, regardless of whether the transaction was standard or nonstandard and the chart 310 indicates the number of days early or late, on average, a report relating to a nonstandard transaction was submitted to an originator. In the example presented here, the charts 304-310 display information over the range of dates specified in the fields 312A and 312B. The range of dates for which information is displayed may be changed by changing the entries in the fields 312A and 312B and activating, for example by clicking with a mouse, the Go button 314.

The page 302 and the information linked to it may suitably be designed to allow a user to navigate freely between evaluation information documents such as charts and other evaluation information documents once the browser window 300 has been reached. For example, clicking one of the charts 304-310 may suitably result in the display of one or more lower level charts adding detail to, or emphasizing various aspects of, the chart which was clicked. In addition, the page 302 includes a hierarchical list 316 of data contained in or relating to the chart 304, as well as lower level charts which may be reached by clicking the chart 304. The user may display a desired chart by making an appropriate selection from the list 316. The page 302 also includes a list 318 of different evaluation information which is available for display, and this the user may display the desired information by making a selection from the list 318. The page 302 also includes a set of navigational tools 320. These tools may be used to navigate to desired information.

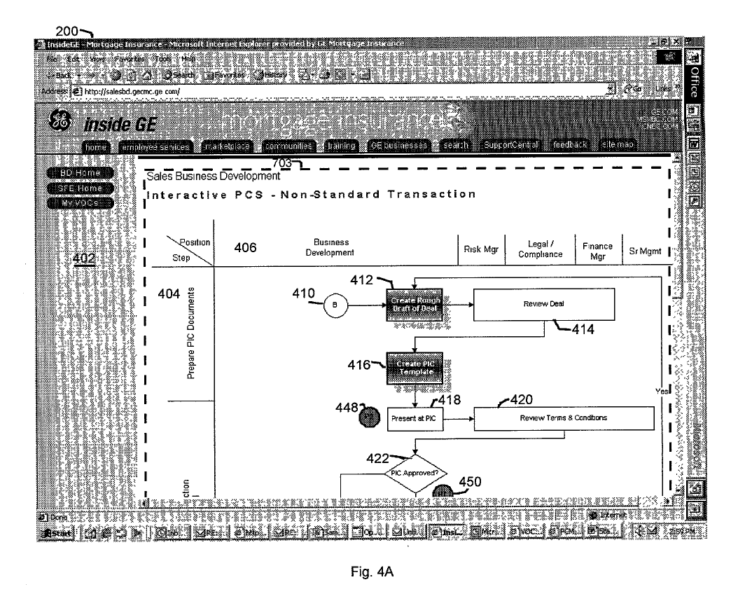

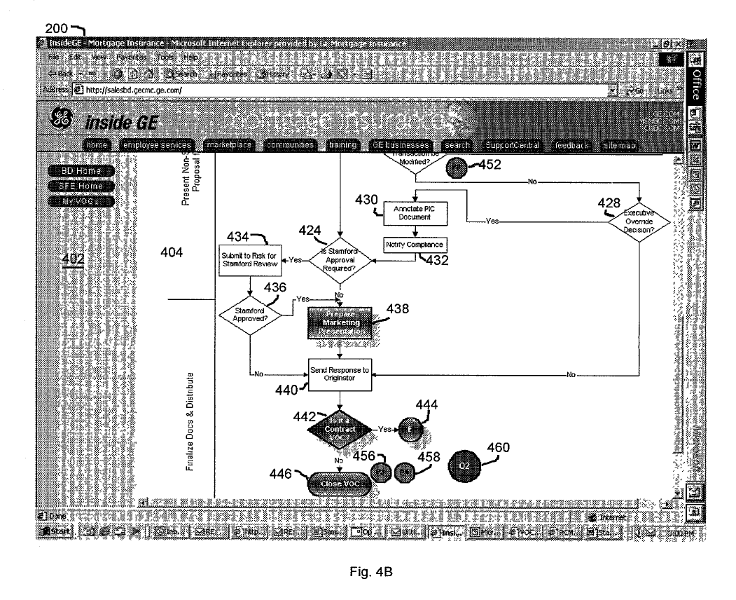

FIGS. 4A and 4B illustrate the browser window 200 displaying a hypertext page 402, reached by activating the link 226 of FIG. 2B. The page 402 contains a process description 403, which describes the process of preparing and completing a non-standard transaction. Preparation and completion of a non-standard transaction is an intermediate level process which may need to be performed to accomplish the core process of business development described in the hypertext page 202 of FIGS. 2A and 2B. FIG. 4A illustrates the upper portion of the page 402 and FIG. 4B illustrates the page 402 when it has been scrolled down to reveal additional material. When a user employing the hypertext page 202 of FIGS. 2A and 2B has determined that the intermediate level process to be accomplished in order to complete a core process step is to prepare and execute a transaction, he or she may activate the link 226 to retrieve the page 402, in order to view the various intermediate level process steps and links involved in preparation and execution of the transaction.

The process description 403 includes marginal legends 404 and 406. The legend 404 indicates the stage of the process at which a step occurs and the legend 406 indicates the parties involved in carrying out a process step. The process description 403 is implemented here as a flowchart including showing the process step descriptions 410-446, as well as links 448-460, used to retrieve evaluation information for the process. Some of the intermediate level process step descriptions, such as the descriptions 410, 41 8 and 420 are ordinary text use to provide guidance on what actions to undertake, while other intermediate level process step descriptions, such as 416 and 444, are used to retrieve resources needed to carry out the intermediate level process or an intermediate level process step or to retrieve a lower level process description describing a lower level process which needs to be performed in order to carry out the intermediate level process or intermediate level process step.

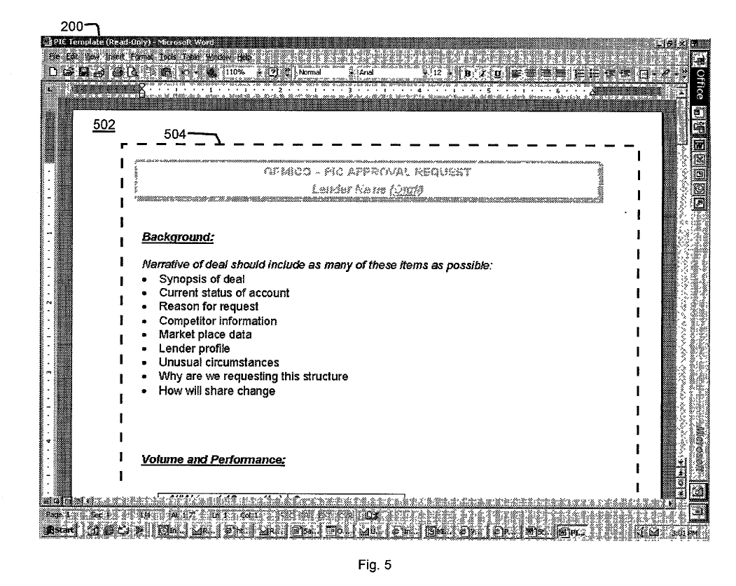

FIG. 5 illustrates the browser window 200 displaying a hypertext page 502, reached upon activating the link implemented in the process step description 416.

The page 502 includes a resource list 504. The resource list 504 includes descriptions of and links to resources for creation of a PIC template, which is the process step described in the description 716. The resource list 504 also includes guidance for carrying out the process step.

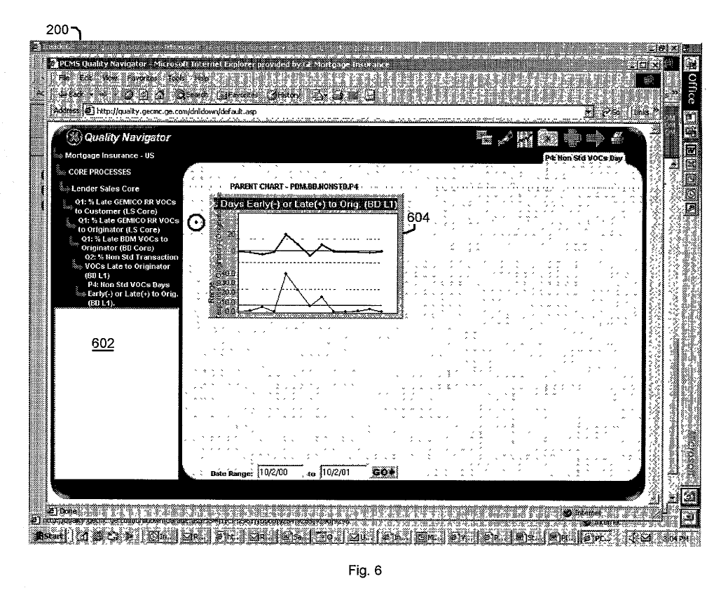

FIG. 6 illustrates the browser window 200 displaying a hypertext page 602 containing a display of an evaluation information document relating to performance of the intermediate level process of completion of a non-standard transaction, described by the description 403. The evaluation information document is in the form of a chart 604. The web page 602 is retrieved and displayed when a user activates the link 458 of FIG. 4B. The chart 604 illustrates how many days early or late, on average, a non standard transaction is processed and the result submitted to the originator of the request. A user can click the chart 604 to retrieve additional charts showing additional details of the information, and can use the hypertext page 602 to navigate through evaluation information in a way similar to that described in connection with FIG. 3.

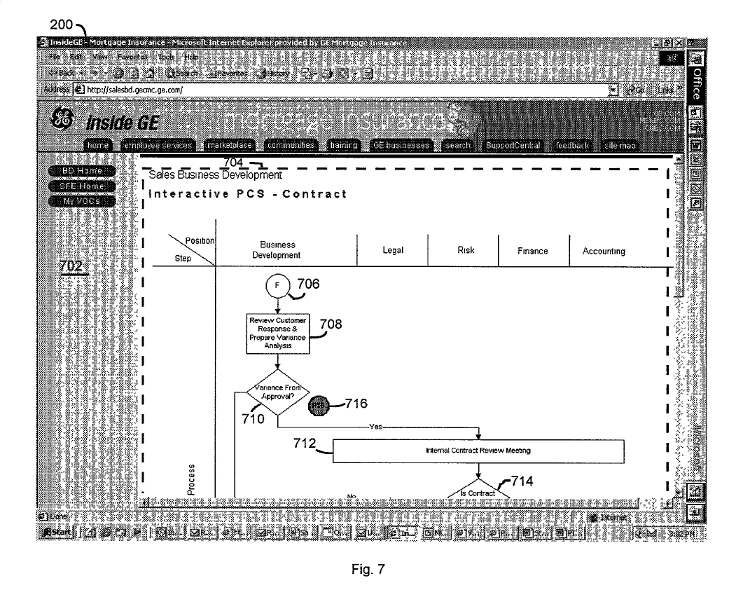

FIG. 7 illustrates the browser window 200 displaying a portion of a hypertext page 702, reached by activating the link associated with the label 444 of FIG. 4B. The page 702 includes a lower level process description 704 of the process of contract development and execution. The process of contract development and execution is a lower level process which must be performed when the flow of the intermediate level process described by the description 403, that is, transaction preparation, reaches the label 444. The description 704 is implemented as a flowchart and includes process steps necessary to carry out the process, of which the steps 706-71 4 are visible here. The description 704 also includes a label 716 implementing a hypertext link. Activating the link associated with and implemented by the label 716 retrieves one or more evaluation information documents related to the performance of the process, which may suitably be presented as one or more charts on a hypertext page similar to the pages 302 and 602 of FIGS. 3 and 6, respectively.

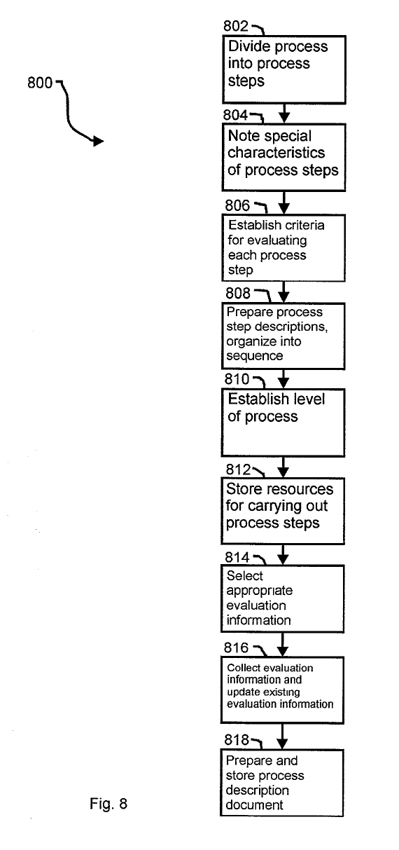

FIG. 8 illustrates a method 800 of creating a process description and providing facilities for collecting and storing evaluation information relating to the process and providing access to the evaluation information according to an aspect of the present invention. The process 800 may suitably be carried out using a system similar to the system 100 of FIG. 1. At step 802, the process is analyzed and divided into a sequence of process steps which must be accomplished in order to complete the process. Process steps may include preparation of forms, gathering of information, verification of information, obtaining approval or any of a number of other process steps which may be required for the carrying out the process. At step 804, each process step is examined and special characteristics associated with each process step are noted. For example, resources required to complete a process step may require the participation of an outside vendor such as a real estate appraiser, copy shop or the like, the step may require information to be provided by the customer, or the process step may require approval by more senior management than in a routine case. For example, the level of approval required for a process step may vary depending on the sum of money at risk. At step 806, criteria for evaluating the performance of each process step, and of the overall process, are established. At step 808, a description of each process step is prepared and the process step descriptions are organized into a sequence describing the process as a whole. At step 810, an appropriate hierarchical level for the process is established. For example, a process may be designated as a core process, an intermediate level process or a lower level process.

At step 81 2, resources and guidance for carrying out the process are stored as appropriate, preferably in electronically accessible format so that the resources can be easily retrieved. The resources may suitably be stored in the form of a hypertext page containing a resource list similar to the resource list 504 of FIG. 5. At step 814, evaluation information appropriate for evaluating performance of each of the process steps and the process as a whole is selected, suitably from a set of evaluation information documents previously stored in electronically accessible format in a library. Examples of such evaluation information documents are the charts 304-310 of FIG. 3. If no suitable stored information exists, appropriate evaluation information is created and stored, indicating a reasonable estimate for how well the process is expected to be performed. For example, if a process description relating to preparing a contract is created, evaluation information may be stored indicating that the contract has been prepared and submitted on time in 90% of cases and within 3 days after a deadline in 99% of cases. Storing such information will help to prevent unexpected zeroes or blank fields from being present, and as data relating to the actual performance of the process is received and stored, any distortion produced by the initially created data will become smaller.

At step 816, tools are designed, or already existing tools are used, for periodically collecting appropriate evaluation information in connection with the performance of the process. These tools may include customer questionnaires, telephone surveys, monthly reports or any other tools which may be convenient or desirable to use. The information collected by these tools is used to update the existing information stored at step 814.

At step 818, an electronically accessible process description document is implemented. The document may suitably be in the form of a flowchart, and may have elements presented in ordinary text and other elements presented as hypertext links.

If a process step can be succinctly described, the process step description for that process step may suitably be ordinary text. Alternatively, the process step description may be a hypertext link to a lower level process description which may be invoked in order to accomplish the process step. The lower level process description may suitably contain a link back to the original process description, to provide an easy means for a user to return to the original process description when finished with the lower level process description. Examples of such documents are the core process description 204 of FIG. 2, the intermediate level process description 403 of FIG. 4 and the lower level process description 704 of FIG. 7.

The process and process step descriptions include links to stored resources useful in performing the process, as well as links to evaluation information. Links to evaluation information relevant to a process step are preferably placed adjacent to the process step description for that process step, while links to evaluation information relevant to the process as a whole are preferably placed at suitable points within the process description.

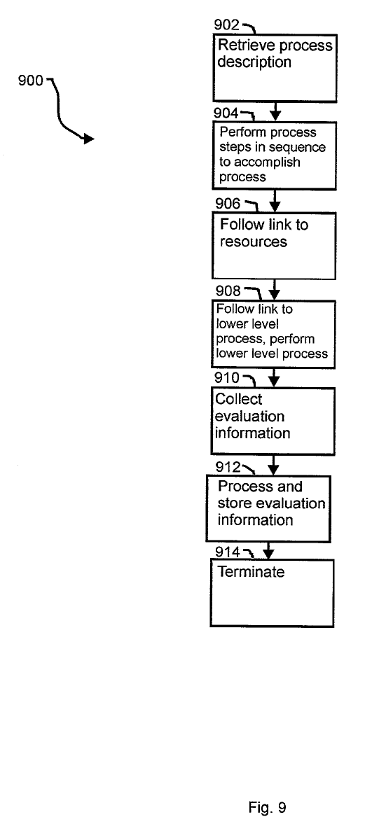

FIG. 9 illustrates a method 900 of performing a process according to the present invention. At step 902, an electronically stored process description document is retrieved. The process description document may suitably be created and stored using a system similar to the system 100 of FIG. 1. The document preferably includes a process description comprising a sequential ordering of process step descriptions, each process step description describing an activity to be undertaken or decision to made in carrying out the process. Selected process step descriptions may suitably take the form of links to lower level processes, for example the link 226 of FIG. 2B. At step 904, the process steps are carried out following a sequence described in the process description document. Whenever a process step description is encountered which links to resources for carrying out the process step, the method proceeds to optional step 906 and the link is followed in order to retrieve the resources. An example of such a link is the link 416 of FIG. 4, causing the retrieval of the page 502 of FIG. 5. Once the resources have been retrieved, the method returns to step 904 and continues following the sequence of process step descriptions.

Whenever a process step description is encountered which links to a lower level process, the method proceeds to optional step 908, the link is followed in order to display a lower level process description for the lower level process and the lower level process is carried out. An example of such a link is the link 226 of FIG. 2B, causing the retrieval of the page 402 of FIG. 4. Upon carrying out the lower level process, the method returns to step 304 and continues with the sequence of process step descriptions.

Whenever desired while following the process description, the optional step 91 0 is performed and evaluation information is collected about the performance of process steps which have been designated as amenable to collection of evaluation information during performance of the process. This information is stored in electronically retrievable format. The evaluation information may, for example, relate to whether the process step was performed on time, how many days early or late the process step was performed, whether the process step was performed correctly, or any other information which may be deemed useful to collect. Collecting the information may be accomplished, for example, by providing a customer or other person or entity for whom the process step is performed with an evaluation form to be completed and submitted. The evaluation form may suitably be a hypertext page which can be submitted electronically, or may be any other type of form which can be conveniently completed and returned. Upon completion of the step 910, the method proceeds to step 912 and the collected information is processed to provide or update information about how well the process step is being performed. The information may include lists of data, averages, graphs or any other suitable presentation of the collected information. The information is stored in electronically retrievable form, with links provided to associate the information with process steps to which it relates, suitably by providing a label implemented as a hypertext link whose activation retrieves a list, chart, or other presentation of the information. An example of such stored information is the page 302 containing the charts 304-310 of FIG. 3, linked to the link 212 of FIG. 2. Upon completion of the step 910, the method returns to step 904 and returns to the sequence of the process description.

Upon completion of all the process steps in a sequence, the method terminates at step 914.

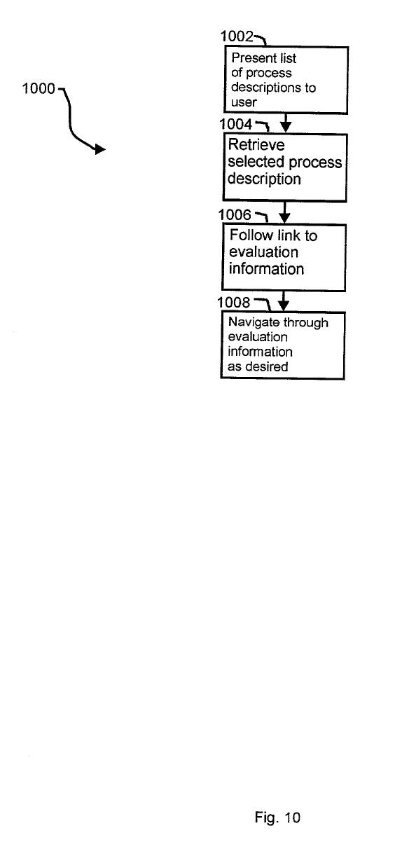

FIG. 10 illustrates a method 1000 according to an aspect of the present invention for retrieval of evaluation information relating to the performance of one or more processes. The method 1000 preferably employs a system similar to the system 1 00, in which a library of process descriptions is stored. Each process description may suitably include a number of links to evaluation information which provides insight into how well various processes have been performed. The evaluation information has preferably been processed, organized and stored so that a particular process and process step may suitably provide links to various sets of evaluation information indicating how well the process or process step is being performed. The evaluation information preferably includes a set of evaluation information documents, each presenting selected evaluation information in a chosen format. Documents may, for example, comprise lists of objectives met or not met, charts showing adherence to or deviations from schedules, average customer waiting time and the like. Each evaluation information document is assigned to a particular level, and documents are preferably linked to processes or process steps having a similar level. Each evaluation information document is preferably linked to other evaluation information documents of the same category, so that retrieval of a document in one category provides linkages to other documents in the category. For example, a document providing evaluation information for a higher level process may be linked to documents providing evaluation information for lower level processes or for lower level process steps making up the process. In this way, a user can easily navigate between levels of a process in order to evaluate the performance of various aspects of the process. At step 1002, list of available process descriptions is presented to a user, with various search and retrieval options also being presented to the user. At step 1004, in response to a user selection, a process description is retrieved. An example of a process description is the description 204 of FIG. 2. At step 1006, in response to user activation of a link to evaluation information within the process description, such as the link 212 of FIG. 2, evaluation information relating to performance of the process of selected process steps is retrieved and displayed, such as the charts 304-310 of FIG. 3. The link may suitably be a link to evaluation information for the process as a whole, of a link to evaluation information for a particular process step, or of a link to other evaluation information which may be available. The display may be in the form of a hypertext page with links to additional hypertext pages including additional information. At step 1008, in response to additional user selections, navigation through available information is performed, with selected information being retrieved and displayed.

While the present invention is disclosed in the context of aspects of an embodiment employing a specific system and exemplary web pages, it will be recognized that a wide variety of implementations may be employed by persons of ordinary skill in the art consistent with the above discussion and the claims which follow below.

1. A method of collecting and storing evaluation information relating to the quality of performance of a process, comprising the steps of:
examining the process to identify individual process steps required by the process;
collecting evaluation information related to one or more process steps and of the overall process;
processing the evaluation information to form a collection of evaluation information documents, each evaluation information document including evaluation information relating to quality of performance of one or more process steps or of the overall process;
storing the evaluation information documents in electronically retrievable format;
creating a description of each process step;
organizing the process step descriptions into a process description comprising a sequence of process step descriptions;
adding to the process description links to appropriate evaluation information documents, each link retrieving an evaluation information document associated with the link upon activation of the link; and
storing the process description in electronically retrievable format.

2. The method of claim 1 wherein the step of processing the evaluation information is followed by a step of organizing the evaluation information documents into levels, each evaluation document being assigned a level based on a level of a process or process step to which an evaluation document relates.

3. The method of claim 2 wherein the step of organizing the evaluation information documents includes establishing links between related evaluation information documents.

4. The method of claim 3 wherein the step of adding to the process description links to evaluation information documents includes establishing a plurality of levels of links, with each level of link retrieving a particular level of evaluation information document.

5. The method of claim 4 wherein the step of adding to the process description links to evaluation information documents is followed by a step of adding to the process description links to resources useful for performing the process.

6. A method of retrieving and examining evaluation information relating to performance of a process, comprising the steps of:
retrieving a process description comprising a sequence of process step descriptions, the process description including a plurality of links to evaluation information documents;
upon activation of a link to an evaluation information document, retrieving the evaluation information document associated with the link; and
displaying the evaluation information document.

7. The method of claim 6 wherein the step of retrieving the evaluation information document includes retrieving one or more additional evaluation information documents related to the evaluation information document retrieved upon activation of the link.

8. The method of claim 7 wherein the step of displaying the evaluation information document is followed by a step of displaying one of the one or more additional evaluation information documents upon selection by a user.

9. The method of claim 8 wherein the step of retrieving the process description is preceded by displaying a list of available process descriptions and receiving a user selection from the list and wherein the step of retrieving the process description comprises retrieving the process description selected from the list.

10. The method of claim 9 wherein the step of displaying the list of available process descriptions is preceded by receiving search terms from a user and wherein the list of available process descriptions is a list of process descriptions conforming to the search terms.

11. A system for creation and storage of process descriptions and collection and retrieval of evaluation information, comprising:
a process description library for storing a plurality of process descriptions in electronically retrievable format;
an evaluation information database for storing a plurality of evaluation information documents stored in electronically retrievable format; and
a process description manager operative to create the process descriptions, the process description manager being operative to include in one or more of the process descriptions one or more links to evaluation information documents, each link causing retrieval of an associated evaluation information document upon activation of the link, the process description manager being operative to store each process description in the process description library upon creation of the process description.

12. The system of claim 11 further comprising an evaluation information manager operative to retrieve and display selected evaluation information documents.

13. The system of claim 12 wherein activation of a link invokes the evaluation information manager and selects for display the associated evaluation information document.

14. The system of claim 13 wherein the evaluation information manager is operative to receive collected evaluation information and process the collected evaluation information to form the evaluation information documents.

15. The system of claim 14 wherein each process description comprises a plurality of process step descriptions arranged in a sequence.

16. The system of claim 15 wherein the process description manager is operative to assign a level to each of the process descriptions and process step descriptions indicating a level in a hierarchy of process descriptions and process step descriptions stored in the process description library.

17. The system of claim 16 wherein each of the evaluation information documents is assigned a level in a hierarchy of levels and wherein at least some of the levels in the hierarchy of evaluation information documents correspond to equivalent levels in the hierarchy of process and process step descriptions.

18. The system of claim 17 wherein one or more of the links in the process description is associated with a process step description.

19. The system of claim 1 8 wherein each link associated with one or more of the process step descriptions is operative to retrieve an evaluation information document having a level equivalent to the level of the process step description with which the link is associated.
